(19) United States
(12) Patent Application Publication
(10) Pub. No.: US 2007/0084396 A1
(43) Pub. Date: Apr. 19, 2007

(54) Compact high-power acoustic tone generator

(76) Inventors: Jay B. Cleckler, Long Beach, CA (US); Ray C. Law, Anaheim Hills, CA (US)

Correspondence Address: STETINA BRUNDA GARRED & BRUCKER, 75 ENTERPRISE, SUITE 250, ALISO VIEJO, CA, 92656, US

(21) Appl. No.: 11/446,931

(22) Filed: Jun. 5, 2006

Related U.S. Application Data
(60) Provisional application No. 60/688,278, filed on Jun. 7, 2005.

(51) Int. Cl. G10K 5/00; G08B 3/00

(52) U.S. Cl. 116/137 R; 340/404.1

(57) ABSTRACT

An acoustic device operative to generate high-power acoustic tones having a combustion based or chemical reaction based fluidic power source, an aeroacoustic generator, an assembly to provide feedback, and an array hosing that shapes the output pattern of the sound waves. The combustion or chemical/energetic reaction of one or more solid and/or liquid chemicals used as the source of pressurized gas is similar to a rocket engine or a gas generator which turns liquid and/or solid fuels into relatively massive volumes of pressurized gas. Examples of these generators are edge tone generators, sirens, vibrating reeds and unstable shock generators. In the case of edge tone generators, a physical resonant cavity assembly must be included around the effluent flow to provide feedback serving the purpose of stabilizing the output acoustical power and tonal properties. An array assembly is added to the aeroacoustic generator in order to shape the output pattern of the sound energy.

### CROSS-REFERENCE TO RELATED APPLICATIONS

The present application claims priority to Provisional Patent Application Ser. No. 60/688,278, filed on Jun. 7, 2005, entitled COMPACT HIGH-POWER ACOUSTIC TONE GENERATOR.

### STATEMENT RE: FEDERALLY SPONSORED RESEARCH/DEVELOPMENT

This invention was developed at least in part with funds from the federal government. The government therefore has certain rights to this invention.

### BACKGROUND

The present invention relates in general to an acoustic source for generating sound waves, and more particular, to an aeroacoustic device for generating high-power tones.

Acoustic sources are the generic category of devices that make sounds. Within this category are aeroacoustic generators which create sound by modulating a stream of gas. One particular type of aeroacoustic generators is the edge-tone generator. The category of whistles is subsumed within the larger category of edge-tone generators. With less generality, available literature often refers to edge-tone generators as whistles. Edge-tone generators create sound by using an edge with a sharp, blunt or irregular configuration to modulate a stream of air. The modulated air ultimately results in acoustic waves. The conventional edge-tone generators are deficient in a number of areas. For example, the output power and the tonal qualities are unstable, the sound generation is inefficient, and the size typically too large. The overall size of an aeroacoustic device includes the source of pressurized gas and an aero-acoustic body to modulate the flow of the pressurized gas. The conventional form of the source of pressurized gas includes a compressor, a storage tank or a steam boiler, which are all prohibitively large for portable applications.

### BRIEF SUMMARY

An acoustic device operative to generate high-power acoustic tone is provided. The acoustic device includes a combustion based or chemical reaction based fluidic power source, an aeroacoustic generator, an assembly to provide feedback, and an array hosing that shapes the output pattern of the sound waves.

The combustion or chemical/energetic reaction of one or more solid and/or liquid chemicals used as the source of pressurized gas is similar to a rocket engine or a gas generator which turns liquid and/or solid fuels into relatively massive volumes of pressurized gas. Small amounts of the liquid or solid fuel are used to replace large volume systems such as storage tanks, compressors or steam boilers. As such, the use of solid and/or liquid fuels renders greatly reduced system size compared to the conventional design.

The aeroacoustic generator may be any acoustic radiator producing high-power sound by modulating a stream of compressed gas. Examples of these generators are edge tone generators, sirens, vibrating reeds and unstable shock generators. The generators considered here are those within the categories above that are compatible with hot reaction products resulting from energetic decomposition of the solid or liquid fuel.

In the case of edge tone generators, a physical resonant cavity assembly must be included around the effluent flow to provide feedback serving the purpose of stabilizing the output acoustical power and tonal properties. The physical assembly may also prevent dust or foreign objects from entering the field of effluent flow and thus interrupting the production of high-power sound.

The array assembly may be added to any of the aeroacoustic generators listed above in order to shape the output pattern of the sound energy. Such array assemblies may be used to shape the acoustic output into one or more sound beams or into a more or less uniform pattern. The array assembly is alternatively referred to as a beam former.

The aeroacoustic devices of the present invention may be utilized in a wide variety of applications, such as acoustic sirens, sonic canons/guns and for use in facilitating the sonic agglomeration or threat aerosols, as disclosed and claimed in Applicant's co-pending U.S. Provisional Patent Application Ser. No. 60/688,017, filed Jun. 7, 2005, entitled Application of Sonic Agglomeration to Threat Aerosols, the teachings of which are expressly incorporated herein by reference.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows an embodiment of an acoustic device;

FIG. 2 shows a modification of the acoustic device as shown in FIG. 1;

FIG. 3 shows the creation of sound;

FIG. 4 is a perspective view of a specific type of the acoustic generator;

FIG. 5 is an assembly of two acoustic generators as shown in FIG. 4;

FIG. 6 shows the thermally induced peeling of the annular nozzle of the acoustic device as shown in FIG. 4.

### DETAILED DESCRIPTION

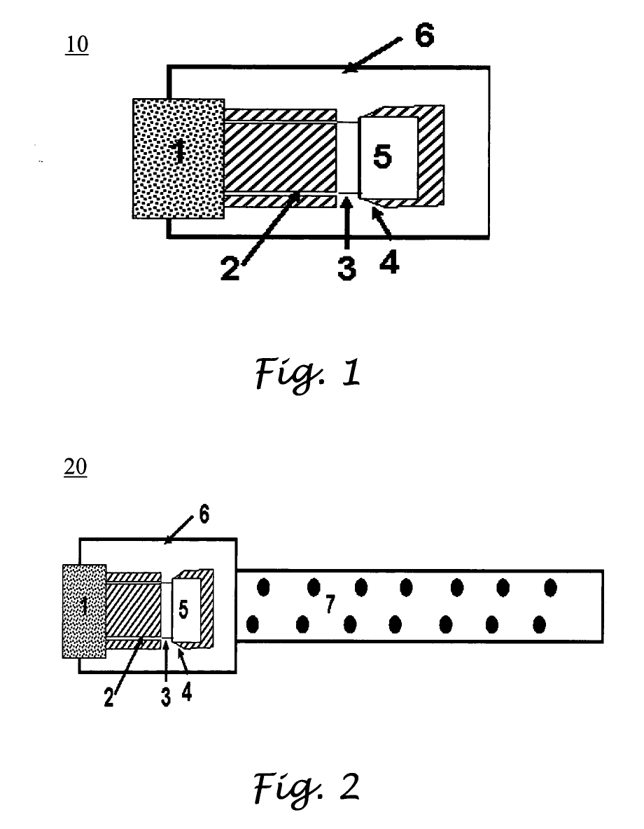

FIG. 1 illustrates a cross sectional view of an embodiment of a high-power acoustic device 10. As shown, the high-power acoustic device 10 includes a source of pressurized gas 1, in which a concentrated hydrogen peroxide monopropellant is decomposed into pressurized steam and oxygen. The effluent gas, that is, the pressurized gas and oxygen in this embodiment, is then pushed through a thin channel 2 and then ejected as a free jet 3 towards a wedge 4 extending around a bottom rim of a housing which surrounds a resonance cavity 5 therein. The free jet 3 is then caused to flow above or below the wedge 4, which ultimately results in the production of high-power sound. The high-power acoustic device 10 further comprises an outer housing 6 for concentrating the high-power sound therein and partially reflecting the high-power sound towards the wedge 4 to provide feedback. FIG. 2 shows a modification 20 of the high-power acoustic device 10. As shown, the high-power acoustic device 10 further comprises an array cavity 7 connected to an output end of the housing 6. The high-power sound that is not reflected back towards the wedge 4 is directed into the array cavity 7, through which the high-power sound is shaped into a narrow axial beam. Preferably, the total volume of the high-power acoustic device 10 is less than one cubic meter and is capable of delivering more than 20 kilowatts of tonal output. The structures and functions for each part of the high-power acoustic 10, including the source pressurized gas 1, the aero-acoustic generator comprising the thin channel 2, the wedge body 4, and the chamber enclosed by the housing 5, the feedback structure, that is, the outer housing 6, and the device for shaping the output pattern of the sound waves, that is, the array cavity 7, will be described in details as follows.

One complication in designing and implementing high-power acoustic (HPA) sources is the energy supply. The sheer magnitude of the acoustic power levels involved with the low efficiencies of many acoustic sources result in input power requirement of kilowatts to produce the desired acoustic amplitudes. For this reason, a variety of acoustic source designs, including electric transducers, sirens, and acoustic oscillators have been experimented. It has been found that the use of acoustic oscillators as the high-power acoustic sources facilitates the desired combination of a high efficiency device and high energy density power supply. Such devices, which are based on flow instabilities, can have acoustic efficiencies greater than 10% and contain no moving parts. Therefore, they are easily adapted for use with rocket-engine type fuel sources.

Creation of sound using flow instability is illustrated By the Von Karman vortex street as shown in FIG. 3. As shown, the cylinders exposed to flows within a broad range of Reynolds numbers (100<Re<1×10⁵) produce unstable separated flows on the leeward side of the cylinder. The flow detaches from one side of the cylinder producing a pressure gradient that leads to the separation of flow on the other side of the cylinder. Despite being unstable, the separated flow oscillates from one side to the other like this with fair regularity. This displacement of flow generates an alternating pressure gradient that radiates in the form of sound waves. In the case of the cylinder these are called “Aeolian tones” and are often produced by wind across familiar cylindrical surfaces such as power lines. The center frequencies of such oscillations can be determined using the Strouhal number:
St=0.2=ƒD/U_{∞}_{₃}

where ƒ is the center frequency of the radiated sound, D is the diameter of the cylinder and U is the free stream velocity of the air. A similar process occurs for an object of any shape immersed in a flow with the proper range of Reynolds numbers.

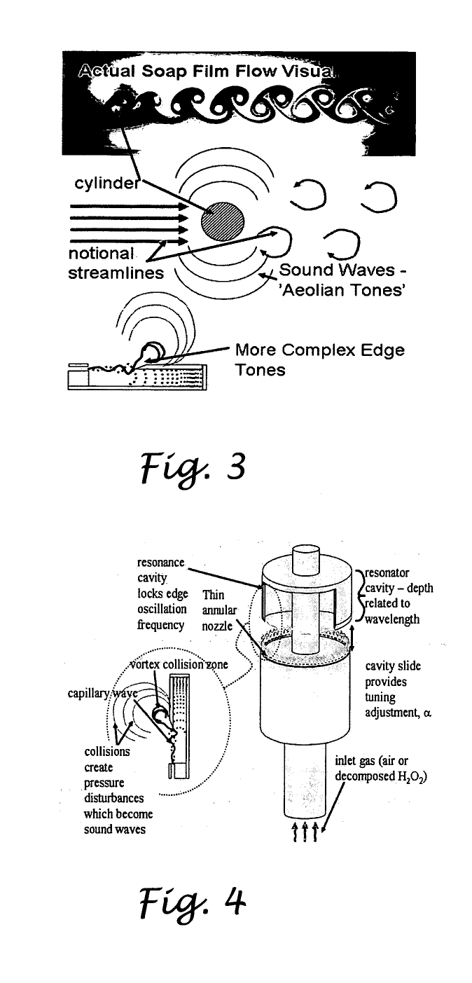

On a qualitative level, the von Karman Vortex street process is very much related to the aero-acoustic generator as discussed above. FIG. 4 illustrates a perspective view of an exemplary type of aero-acoustic generator—the capillary wave oscillator (CWO). The capillary wave oscillator as shown in FIG. 4 includes a very thin annular nozzle to produce a capillary jet. The capillary jet is directed toward a sharp edge to induce the flow behavior as discussed above. The oscillations around the circumference are “locked” onto a single frequency by the resonator cavity, which has been shown in the partial cross-sectional view in FIG. 4. The empirical data shows that, although the depth of the resonator cavity determines the “lock-on” frequency, the depth of the resonator cavity has no linear relation with an integral wavelength of the sound.

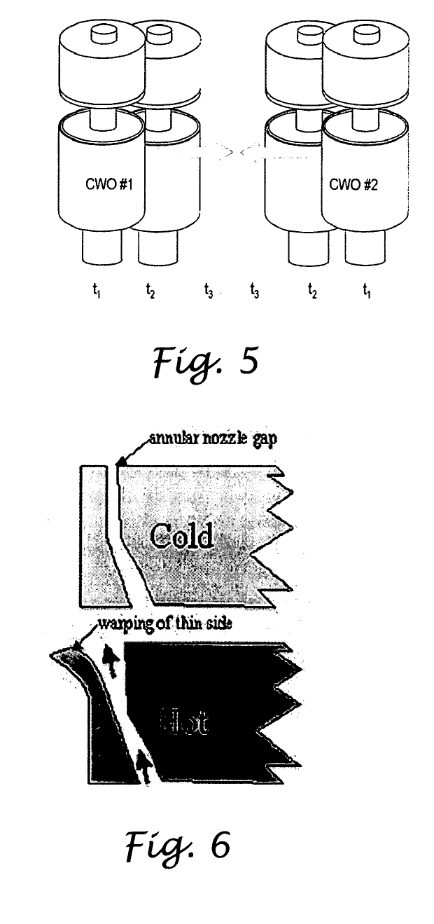

When two of the acoustic sources discussed above are brought closer as shown in FIG. 5, they lock onto a mutual coherent frequency, allowing the contributions from more than one acoustic source to be summed. The mode-locking as shown in FIG. 5 is a non-linear phenomenon that involves the use of one signal to control and lock the frequency of a second, often much larger, signal. The resonant cavity of the capillary wave oscillator is one example of one type of mode locking. In this case, oscillations at any point along the annular cap edge create oscillations in the resonant chamber which force all other points along the edge create oscillations in the resonant chamber which force all other points along the edge to oscillate in phase at that frequency. This results in a strong, coherent, and very pure high-power acoustic tone.

Currently, the highest energy densities available, both by weight and by volume, come from solid gas generators, which are used to describe rocket engine-type sources when they are discharged into a high back pressure. The nearly isentropic expansion of the flow in the capillary nozzle converts internal energy (u=CvT) into kinetic energy, which may then be used to create the desired edge tone disturbances. Further, experiments show that doubling the absolute stagnation temperature of the flow input to the capillary wave oscillator increases the sound output by approximately a factor of 2 (6 dB).

In this embodiment, hydrogen peroxide has been selected as the rocket propellant. Propellant-grade hydrogen peroxide is defined as having a concentration in excess of 60%. The hydrogen peroxide based gas generator has the following advantages. Firstly, hydrogen peroxide is a monopropellant which does not require an additional fuel or combustion system. Secondly, hydrogen peroxide is currently the safest, most logistically and environmentally friendly energetic available propellant and hydrogen peroxide often decomposes into safe product gases such as steams and oxygen. The high temperatures of the hydrogen peroxide generator have implications for design of the capillary wave oscillator sources, but also serve to underscore the importance of the mode locking effect describe above. Particularly, deformation of annular nozzle of the capillary wave oscillator demonstrates no significant change in the output sound characteristics such as amplitude, frequency and stability even though the initial dimensions of the annulus are essential in determining these characteristics. Run times of the capillary wave oscillator are sufficiently short such that the hot reaction products resulting from decomposition of hydrogen peroxide never bring the capillary wave oscillator into thermal equilibrium and the mass difference between the two components of the annulus results in significant differential heating. The outer, lower-mass component of the annular nozzle of the capillary wave oscillator heats so quickly relative to the inner portion that the outlet area of the annulus grows continuously during a thirty second test. This thermally induced “peeling” of the annular nozzle is illustrated in FIG. 7. The outlet area of the nozzle is a critical parameter in the operation of the capillary wave oscillator, and such peeling effect seems detrimental to performance of the generator. However, because of the powerful effect of mode locking, empirical data shows that a capillary wave oscillator that starts at a frequency dictated in part by the initial nozzle outlet area stays at that frequency despite the fact that the outlet area increases by a factor of ten.

The capillary wave oscillator as described above produces extremely pure tones with very little harmonic distortion. This results in almost all the output power to be concentrated in the fundamental frequency, producing extremely high intensity signals in very narrow frequency bands. Currently, the acoustic device as provided is approximately the size of a small automobile tire (16 inches in diameter) powered by a hydrogen peroxide gas generator as described is operative to generate RMS acoustic power as high as 50 kilowatts.

The acoustic devices of the present invention, as will be appreciated by those skilled in the art, may be utilized in a wide variety of applications, exemplary of such applications include the use of such acoustic devices as sirens or for any purpose where a high energy acoustical output is desired. Along these lines, the acoustic devices of the present invention may be utilized in sonic canon/gun devices and systems, chemical engineering processes to facilitate or enhance certain chemical reactions, and may further be utilized to facilitate the sonic agglomeration of threat aerosols. With respect to the latter, Applicant expressly contemplates that the same may be utilized according to Applicant's co-pending U.S. Provisional Patent Application Ser. No. 60/688,017, filed Jun. 7, 2005, entitled Application of Sonic Agglomeration to Threat Aerosols, the teachings of which are expressly incorporated herein by reference.

The above description is given by way of example, and not limitation. Given the above disclosure, one skilled in the art could devise variations that are within the scope and spirit of the invention disclosed herein, including various types of propellants and various configurations of the nozzle and the cavity. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An aeroacoustic device, comprising at least one compact pressurized flow generator operative to produce a stream of pressurized fluid by using reaction products of chemical combustion or chemical decomposition.

2. The aeroacoustic device of claim 1, wherein the compact pressurized flow generator includes a rocket engine.

3. The aeroacoustic device of claim 1, wherein the compact pressurized flow generator includes a hydrogen peroxide monopropellant gas generator, a hydrazine monopropellant gas generator or a solid propellant gas generator.

4. The aeroacoustic device of claim 1, further comprising an aeroacoustic generator operative to modulate the stream of pressurized fluid into a single-frequency sound wave with power exceeding 20 kilowatts per cubic meter of total device volume.

5. The aeroacoustic device of claim 4, wherein the aeroacoustic generator includes an edge-tone acoustic generator.

6. The aeroacoustic device of claim 5, wherein the aeroacoustic generator includes a whistle.

7. The aeroacoustic device of claim 4, further comprising a housing structure operative to shape the sound wave into a desired output pattern.

8. The aeroacoustic device of claim 7, wherein the desired output pattern includes a narrow axial beam.

9. The aeroacoustic device of claim 7, wherein the housing includes an array of cavities.

10. The aeroacoustic device of claim 4, wherein the aeroacoustic generator includes:
a housing surrounding a resonant cavity; and
a wedge aligned with the stream of pressurized fluid.

11. The aeroacoustic device of claim 10, further comprising a channel operative to eject the stream of pressurized fluid flowing therethrough into a free jet.

12. The aeroacoustic device of claim 10, further comprising a housing enclosing the aeroacoustic generator for concentrating the sound wave therein.

13. The aeroacoustic device of claim 10, wherein the housing is operative to reflect the sound wave back to the wedge.

14. An aeroacoustic device, comprising:
a source of pressurized fluid;
a channel connected to an output of the pressurized fluid, so as to eject the pressurized gas as a free jet;
an acoustic generator operative to modulate the pressurized fluid into high-power sound waves, comprising:
a housing surrounding a resonant cavity for the free jet;
a wedge extending from a rim of the housing to cause the free jet to separate the free jet into two flows above and below the wedge; and
an exterior housing enclosing the housing and the wedge therein.

15. The aeroacoustic device of claim 14, further comprising an array hosing for shaping an output pattern of the sound waves.

16. The aeroacoustic device of claim 14, wherein the source of pressurized fluid is operative to decompose concentrated hydrogen peroxide monopropellant into pressurized steam and oxygen.

17. An aeroacoustic device, comprising:
at least one capillary wave oscillator, which comprises:
a source of pressurized fluid operative to generate a stream of pressurized fluid;
a nozzle operative to eject the stream of pressurized fluid as a thin jet;
a wedge aligned with the thin jet; and
a resonant cavity for resonating the thin jet into a lock-on frequency.

18. The aeroacoustic device of claim 14 operated with one or more additional aeroacoustic devices in such a way that the tonal output of all such aeroacoustic devices is locked in frequency and phase.
